(19) United States
(12) Patent Application Publication
(10) Pub. No.: US 2013/0194399 A1
(43) Pub. Date: Aug. 1, 2013

(54) SYNCHRONIZATION OF SHUTTER SIGNALS FOR MULTIPLE 3D DISPLAYS/DEVICES

(71) Applicant: Rene Wirtz, Stuttgart (DE)

(72) Inventor: Rene Wirtz, Stuttgart (DE)

(73) Assignee: Sony Corporation, Minato-ku, TOKYO (JP)

(21) Appl. No.: 13/809,528

(22) PCT Filed: Jul. 14, 2011
(86) PCT No.: PCT/EP2011/062093

§ 371 Date: Mar. 28, 2013

(30) Foreign Application Priority Data
Jul. 21, 2010 (EP) 10170342.9

(51) Int. Cl. H04N 13/04

(52) U.S. Cl. CPC H04N 13/0438
USPC 348/53

(57) ABSTRACT

A device for controlling shutter glasses used in a 3D display system, including: a generator unit generating sync signals used to synchronize shutter glasses with the 3D display system, the sync signals having a timing and a sync rate; a transmit unit for transmitting the sync signals to the shutter glasses, and a sync signal adjusting unit coupled to the generator unit and configured to adjust the timing and/or sync rate of the sync signal generated by the generator unit. The adjusting unit includes a transmit element transmitting an adjusting signal indicating the timing and/or the sync rate and receivable by other devices for controlling shutter glasses.

### FIELD OF INVENTION

The present invention relates to a device for controlling shutter glasses used in a 3D display system. The invention also relates to a method for controlling shutter glasses and a display system for displaying 3D content comprising a device for controlling shutter glasses.

### BACKGROUND OF THE INVENTION

The presentation of 3D content, particularly 3D motion pictures, becomes more and more popular and therefore increases the demand on 3D display systems employing techniques of 3D presentation. Generally, there are several techniques to produce and display 3D moving pictures. Common 3D display technology for projecting stereoscopic image pairs to the viewer includes for example alternate-frame sequencing requiring active shutter glasses. The core concept of this display technology is to display left and right images (frames) alternately and to open and close the shutters in the glasses in synchronization with the images on the display. In other words, the shutter glasses ensure that the right eye of the viewer only see the right image and the left eye the left image which in total give the viewer a three dimensional or stereoscopic impression.

One requisite for a proper functioning of such a 3D display system is synchronization between the presentation of the left and right images and the opening and blocking of the respective glasses of the shutter glasses.

Generally, this synchronization is achieved by transmitting a synchronization signal (also often called timing signal; hereinafter also called sync signal) from the display system to the shutter glasses. In response to this synchronization signal the shutter glasses open or close (block) the left and right glass, respectively. The synchronization signal itself is transmitted preferably wirelessly, for example as an infrared signal.

Although such 3D display systems in conjunction with shutter glasses operate quite satisfactorily, a viewer may encounter problems in a scenario where two or more 3D display systems are located within the field of vision of the viewer. These problems may arise by the fact that the several display systems do not use the same synchronization signals to control the shutter glasses.

### SUMMARY OF INVENTION

In view of the above it is an object of the present invention to provide a device for controlling shutter glasses used in a 3D display system which overcomes the above-mentioned disadvantages. In particular, the device for controlling shutter glasses should ensure that the viewer can use the same shutter glasses for viewing 3D content, like 3D motion pictures on several displays or screens for example concurrently.

According to an aspect of the present invention there is provided a device for controlling shutter glasses used in a 3D display system comprising a generator unit for generating sync signals used to synchronize shutter glasses with the 3D display system, the sync signals having a timing and a sync rate;

a transmit unit for transmitting the sync signals to the shutter glasses, and a sync signal adjusting unit coupled to the generator unit and adapted to adjust the timing and/or the sync rate of the sync signal generated by the generator unit, wherein said adjusting unit comprises a transmit element for transmitting an adjusting signal indicating the timing and/or the sync rate and receivable by other devices for controlling shutter glasses.

According to another aspect of the present invention there is provided a device for controlling shutter glasses used in a 3D display system, comprising a generator unit for generating sync signals used to synchronize shutter glasses with the 3D display system, the sync signals having a timing and a sync rate; a transmit unit for transmitting the sync signals to the shutter glasses and a sync signal adjusting unit coupled to the generator unit and adapted to adjust the timing and/or the sync rate of the sync signal in response to an adjusting signal, wherein said adjusting unit comprises a receive element for receiving an adjusting signal indicating the timing and/or the sync rate and transmitted by any other device for controlling shutter glasses.

In other words, the present invention suggests a sync signal adjusting unit which is capable to adjust the sync signal transmitted to shutter glasses in response to a certain adjusting signal provided by another device for controlling shutter glasses.

On the basis of such a device for controlling shutter glasses it is possible to synchronize the sync signals transmitted by different 3D display systems. Hence, all devices transmit the sync signals simultaneously to for example open the left glass of the shutter glasses.

As a result the viewer does not encounter any problems when directing his view from one display to another within a multi display system environment.

In the context of the present invention, “timing” means the point of time when the sync signal is to be transmitted. The expression “sync rate” means the frequency used for transmitting the sync signal periodically. Further, the expression “coupled” means that there is any signal or communication path between the coupled members regardless whether the path is a direct or indirect path, e.g. via further members.

In a preferred embodiment, the transmit element comprises an emitting element for transmitting said signal wirelessly. More preferably, the emitting element is an RF radiating element.

The advantage of transmitting the adjusting signal wirelessly, preferably as an RF signal is that this kind of transmission is less susceptible to obstacles in the path between two or more devices. Any wireless technology, like Bluetooth, is employable for transmitting the adjusting sinal.Other methods for transmitting, like infrared transmission or a transmission by wire would also be possible.

In particular, it would be possible to transmit the sync signal adjusting signal by using HDMI or Ethernet.

In a preferred embodiment, said receive element comprises a receiving element for receiving said signal wirelessly. Preferably, said receiving element is an RF antenna element.

In a further preferred embodiment, said transmit element is adapted to transmit said adjusting signal periodically. More preferably, said adjusting signal is a trigger signal, preferably an analogue trigger signal.

That is in other words that the signal transmitted does not contain any information used for adjusting the sync signal. In contrast, the signal itself triggers the generator unit to generate a sync signal.

An advantage is that it is a simple signal requiring only simple circuitry.

Of course it would also be possible to transmit a signal in analog or digital form containing information about the timing and/or sync rate. However, such a signal requires circuitry for analyzing and extracting information from the transmitted signal which is more expensive.

In a further preferred embodiment, said adjusting unit is adapted to provide a signal to a picture processing unit of the 3D display system as to synchronize the timing of the left and right picture frame display.

That is in other words that the adjusting unit generates and transmits a signal which is used to synchronize the picture frames to the sync signal transmitted to the shutter glasses. That is, the display systems display the left and right images, respectively, simultaneously.

According to a further aspect of the present invention there is provided a method for controlling shutter glasses used in a 3D display system comprising the steps:

generating sync signals used to synchronize shutter glasses with a 3D display system, the sync signals having a timing and a sync rate;

transmitting said sync signals so that the signals are receivable by shutter glasses;

transmitting an adjusting signal indicating the timing and/or the sync rate of the generated sync signals.

According to a further aspect of the present invention there is provided a method for controlling shutter glasses used in a 3D display system, comprising the steps:

generating sync signals used to synchronize shutter glasses with a 3D display system, the sync signals having a timing and a sync rate;

transmitting said sync signals so that the signals are receivable by shutter glasses;

receiving an adjusting signal indicating the timing and/or the sync rate; and

adjusting the time and/or the sync rate of the generated sync signals in response to the adjusting signal.

In a preferred embodiment, the method further comprises an arbitration step between several participating 3D display systems for finding and determining a timing and/or sync rate being appropriate for all participating 3D display systems.

In an environment having several display systems it is very likely that the display systems operate with different frame repetition rates. As a result, the sync rates of the synchronization signals transmitted to the shutter glasses are also different. In order to synchronize the shutter glasses within this environment, it is necessary to agree to one common sync rate which may be employed by all display systems. The arbitration step is used to find out this common sync rate.

Under normal circumstances, the arbitration step searches for the fastest sync rate usable by every display system within the environment.

According to a further aspect a display system for displaying 3D content, preferably motion pictures, comprising a device for controlling shutter glasses according to the present invention is provided. Further, also a system comprising at least two such display systems is provided.

Preferred embodiments of the invention are defined in the dependent claims as mentioned before. It shall be understood that the claimed method has similar and/or identical preferred embodiments as the claimed device and as defined in the dependent claims.

The present invention is based on the idea to bring the sync signals transmitted by different display systems in synchronization with each other meaning that all shutter glasses used in such an environment with several display systems block and open simultaneously the left and right glasses, respectively,.

### BRIEF DESCRIPTION OF DRAWINGS

These and other aspects of the present invention will be apparent from and explained in more detail below with reference to the embodiments described hereinafter. In the following drawings

FIG. 1 shows a schematic view of a display system with shutter glasses;

FIG. 2 shows a block diagram of two identical devices for controlling shutter glasses; and

FIG. 3 shows a system containing several display systems each comprising a device for controlling shutter glasses according to the present invention.

### DESCRIPTION OF PREFERRED EMBODIMENTS

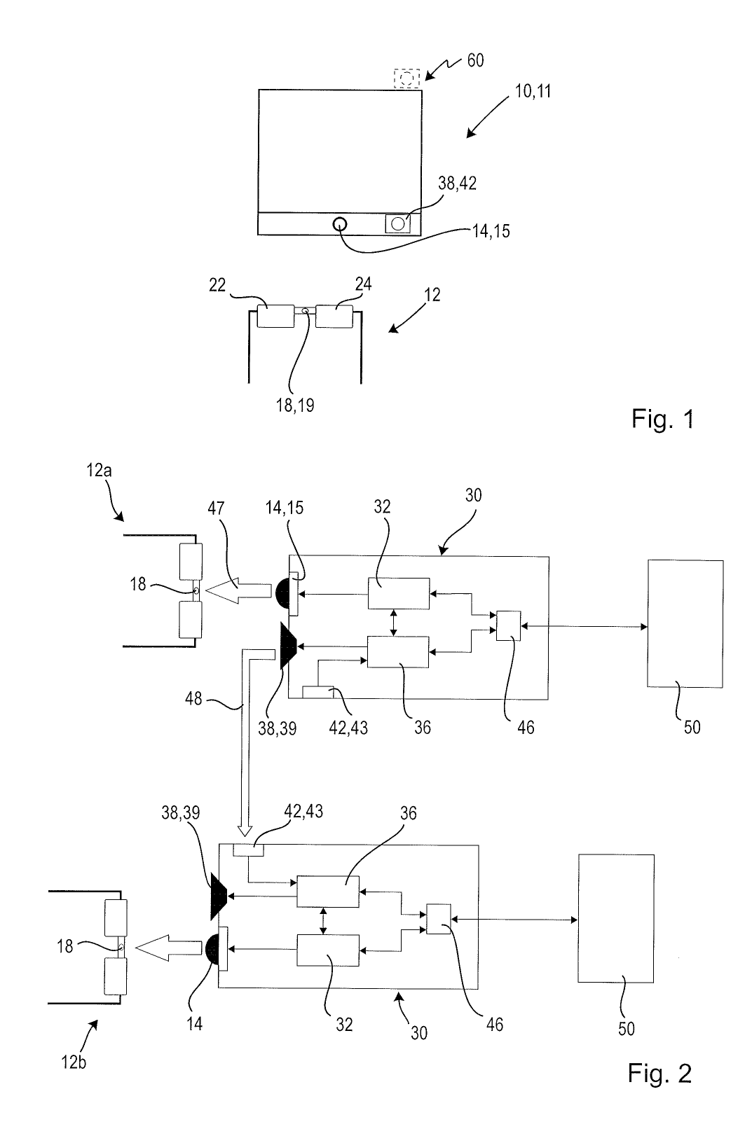

In FIG. 1, a schematic illustration of a display system is shown and indicated with reference numeral 10. The display system 10 is preferably provided as a TV set 11. The display system is adapted to process and display 3D motion pictures meaning that left and right images (frames) are alternately displayed.

In order to get a stereoscopic impression of the displayed images, the viewer has to wear shutter glasses which are also schematically shown in FIG. 1 and indicated with reference numeral 12. Common shutter glasses comprise a left and a right glass 22, 24 which may be switched between a transparent and a light blocking state. Preferably, both glasses use LCD technology to provide the light blocking state by applying a drive voltage. By applying said drive voltage to the left and right glasses alternately, the left and right glasses change their state alternately as well. That is, in operation only one of both glasses is transparent whereas the other one is in the light blocking state. Of course, the mentioned LCD technology is only an example and other technologies are also conceivable.

In order to create the stereoscopic impression, it is necessary that the viewer sees the left image on the display with his left eye and the right image with his right eye only. Consequently, synchronization between the display system 10 and the shutter glasses 12 is necessary.

In the prior art, several methods are known, all of which could be used in conjunction with the present invention. Just as an example, an infrared signal is used to provide the mentioned synchronization. In detail, the display system 10 comprises a transmit unit preferably in form of an infrared light emitting diode which is adapted to transmit a synchronization (also called sync) signal to the shutter glasses. The shutter glasses 12 in turn comprise a receive unit 18, preferably in form of an infrared phototransistor 19, adapted to receive the transmitted sync signal. In response to the received sync signal the glasses are switched between the transparent and light blocking states.

In other words, the display system transmits a signal for switching the left glass in the light blocking state and the right glass in the transparent state and then transmits a further signal for switching the left glass in the transparent state and the right glass in the light blocking state.

In FIG. 2, a schematic block diagram of a shutter glasses control device is shown and indicated with reference numeral 30. This shutter glasses control device is at first instance adapted to generate the afore-mentioned sync signal. It therefore comprises a sync signal generator unit 32 which is electrically coupled to the transmit unit 14, preferably an infrared LED. The sync signal generator unit 32 generates an electric signal which causes the infrared LED 15 to switch on and off The respective light beam, which is referenced by reference numeral 47, is received by the receive unit 18 of the shutter glasses 12.

Since the generation of the sync signals is dependent on the display of the respective left and right images (frames), the sync signal generator unit 32 is also electrically coupled with a picture processing unit 50, preferably via an interface 46 forming part of the shutter glasses control device 30.

The shutter glasses control device 30 also comprises a sync signal adjusting unit 36 which is electrically coupled with a transmit element 38 and a receive element 42. The transmit element 38 is preferably provided as an RF radiating element and the receive element 42 is preferably provided as an RF antenna element matched to the frequency used by the RF radiating element 39.

Further, the sync signal adjusting unit 36 is electrically coupled with the interface 46. This connection allows to build up a communication between the sync signal adjusting unit 36 and the picture processing unit 50.

Further, it is indicated in FIG. 2 that there is also an electrical connection between the sync signal adjusting unit 36 and the sync signal generator unit 32. The sync signal adjusting unit is able to modify the timing and sync rate used by the sync signal generator unit 32 for generating the sync signal. For example, by sending respective signals to the sync signal generator unit 32, the sync signal adjusting unit is able to for example shift the timing of the transmitted sync signal and/or the sync rate of the sync signal.

The respective behavior will be explained in detail below.

The shutter glasses control device 10 and the picture processing unit 50 form part of a first display system 10, wherein the shutter glasses control device may be provided as an inbuilt device of the display system 10 or a separate unit which may be electrically coupled with the display system 10. Of course it is also conceivable that the sync signal generator unit 32 and the transmit unit 14 are part of the display system, and the sync signal adjusting unit 36 together with the transmit element and the receive element 38, 42 are provided as a separate unit as for example shown in broken lines in FIG. 1 and referenced by reference numeral 60.

In FIG. 2, a further identical shutter glasses control device 30 is shown. However, this control device and the coupled picture processing unit 50 are part of a second display system.

Under normal circumstances, the shutter glasses control device 30 of the first display system would transmit a sync signal to the shutter glasses 12a with a first timing and sync rate, whereas the shutter glasses control device 30 of the second display system would transmit a sync signal to the shutter glasses 12b with a second timing and sync rate. It is very likely that the timing as well as the sync rate of both display systems are different with the result that a viewer cannot properly view the motion pictures displayed by both display systems simultaneously.

In order to overcome this disadvantage and to synchronize the sync signals transmitted by both shutter glasses control devices, one of both control devices 30 (the control device of the first display system in this example) transmits an adjusting signal 48 via the RF radiating element 39. This adjusting signal indicates the timing and/or the sync rate of the transmitting control device 30.

The adjusting signal is received by the RF antenna element 43 of the control device 30 of the second display system. This adjusting signal is processed by the sync signal adjusting unit 36 as to provide a signal for the sync signal generator unit. This signal causes the generator unit 32 to generate a sync signal having the same timing as the sync signal of the first display system. Of course the sync rate used by the generator unit 36 of the second display system should also be the same as in the first display system.

As already mentioned before, the sync signal indicates whether a left or right image is displayed on the display. As a consequence, when adjusting the timing of the sync signal for example in the second display system, it is also necessary to adjust the timing of the respective display of the left and right images. Therefore, the sync signal adjusting unit 36 also transmits a signal to the picture processing unit 50 to also adjust the timing of the left and right image displays.

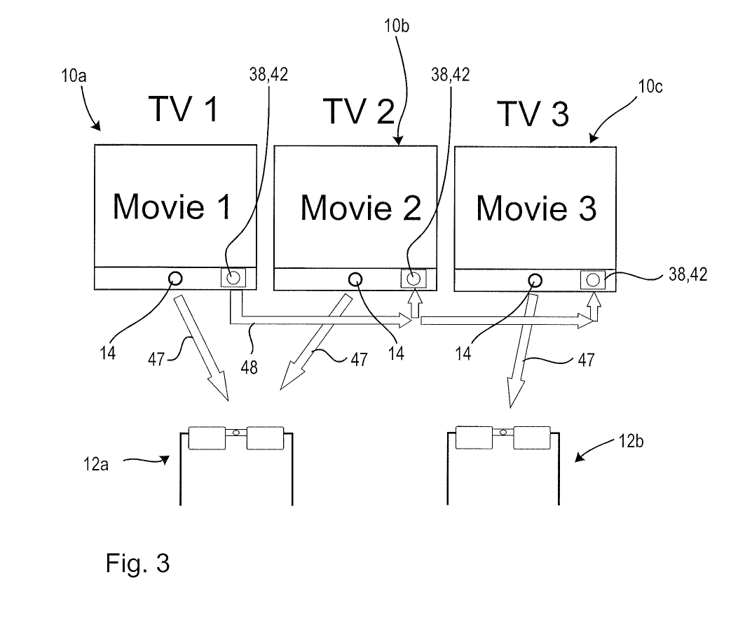

In FIG. 3 a system environment is schematically shown comprising three display systems 10a, 10b and 10c. The display systems 10a, b, c are provided as TV sets and are used to display three different 3D movies.

Further, within this environment, two viewers using shutter glasses 12a and 12b, respectively, are viewing the movies.

Under normal circumstances, the sync signals 47 transmitted by each TV set are not synchronized so that a viewer may encounter problems because his shutter glasses receive different sync signals from different TV sets.

The present invention now avoids such problems by employing the shutter glasses control device 30.

In the present example, the first display system 10a generates an adjusting signal 48 which is transmitted via the transmit element 38 of the shutter glasses control device 30. This adjusting signal 48 is received by the second and the third display system 10b and 10c via the receive element 42. The received adjusting signal 48 is then used to adjust the timing of the sync signals transmitted by the second and third display systems 10b, 10c. After this adjusting step, all three TV sets transmit simultaneously the sync signals 47 with the same timing and sync rate. In this example, the first display system 10a operates like a master (with respect to the sync signal) and the other display systems operate as slaves accordingly that is they adjust the timing of the sync signals dependent on the first display system. Of course, it would also be conceivable that a separate unit merely comprising a device for controlling shutter glasses operates as the master in a multi display system environment. Further, in certain cases, the display systems operating as slaves could be equipped with a control device only having a receive element for receiving the adjusting signals.

As already mentioned before, adjusting the timing of the sync signal also requires adjusting the timing of the display of the left and right images.

As a result of the adjusting step, all display systems, here TV sets, display simultaneously the left images and right images, respectively,. Hence it does not play any role whether the viewer wearing the shutter glasses 12a or 12b, receives the sync signal 47 from the first, the second or the third display system.

Consequently, regardless whether the viewer directs his view to any of the three display systems, his shutter glasses always receive the proper sync signal so that problems caused by interfering sync signals are avoided. Further, the viewer may view all three movies without any problems because the display of the left and right images is also synchronized between the several display systems 10a, b, c.

In the event that at least one of the display systems of the system environment shown in FIG. 3 operates with a different sync rate (meaning that the picture or frame repetition rate is different), an arbitration step is carried out before the adjusting step. By the arbitration step, all three display systems communicate with each other as to search for a common sync rate which may be employed by every display system. For example, if one of the display systems has a frame repetition rate of 60 Hz and the other display systems have 120 Hz, the arbitration step causes the latter display systems to switch down to a frame repetition rate of 60 Hz.

Although the control devices 30 explained in detail above use wireless techniques to transmit the adjusting signals between several display systems, it is also possible to transmit these signals via cables. The HDMI interfaces could for example be used for connecting the display systems with each other as to transmit the adjusting signals. Of course, other interfaces, like Ethernet, etc. would also be possible.

Further, the present invention has been described in conjunction with TV sets. However, the control devices according to the present invention could also be used in Blu-Ray players, video game consoles, Personal Computers, etc.

The present invention is for example useful at exhibitions with multiple TV sets placed in one location and showing different programs. With just one synchronized signal for the shutter glasses from all display devices, one could watch the programs on all TV sets without the need of changing the shutter glasses for each TV. Another example is a LAN-gaming-party. With all the different computers/PlayStations synchronized sync signal, one could walk from player to player and watch all the different screens. In addition there would be no signal interference between the different devices, thereby avoiding problems for the different sets of glasses of the different players/spectators.

The adjusting step as described above could be started for example by pushing a “synchronization” button on a display system. More preferably, the control devices are adapted to automatically check their surroundings for an existing sync signal and to synchronize themselves automatically to an existing sync signal.

The invention has been illustrated and described in detail in the drawings and foregoing description, but such illustration and description are to be considered illustrative or exemplary and not restrictive. The invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1-30. (canceled)

31. A device for controlling shutter glasses used in a 3D display system, comprising:
a generator unit for generating sync signals used to synchronize shutter glasses with the 3D display system, the sync signals having a timing and a sync rate;
a transmit unit for transmitting the sync signals to the shutter glasses; and
a sync signal adjusting unit coupled to the generator unit and configured to adjust the timing and/or the sync rate of the sync signal generated by the generator unit, wherein said adjusting unit comprises a transmit element for transmitting an adjusting signal indicating the timing and/or the sync rate and receivable by other devices for controlling shutter glasses.

32. A device according to claim 31, wherein said adjusting unit comprises a receive element for receiving a sync signal adjusting signal indicating the timing and/or the sync rate and transmitted by any other device for controlling shutter glasses, and said adjusting unit is adapted to adjust the timing and/or the sync rate of the sync signal in response to the adjusting signal.

33. A device according to claim 31, wherein said transmit element comprises an emitting element for transmitting said signal wirelessly.

34. A device according to claim 31, wherein said transmit element is adapted to transmit said adjusting signal periodically.

35. A device according to claim 31, wherein said adjusting signal is a trigger signal, or is an analogue trigger signal.

36. A device according to claim 31, wherein said adjusting signal is a digital signal containing information about the timing and/or the sync rate.

37. A device according to claim 31, wherein said adjusting unit is adapted to provide a signal to a picture processing unit of the 3D display system as to synchronize the timing of the left and right picture frame display.

38. A device for controlling shutter glasses used in a 3D display system, comprising:
a generator unit for generating sync signals used to synchronize shutter glasses with the 3D display system, the sync signals having a timing and a sync rate;
a transmit unit for transmitting the sync signals to the shutter glasses; and
a sync signal adjusting unit coupled to the generator unit and adapted to adjust the timing and/or the sync rate of the sync signal in response to an adjusting signal, wherein said adjusting unit comprises a receive element for receiving an adjusting signal indicating the timing and/or the sync rate and transmitted by any other device for controlling shutter glasses.

39. A device according to claim 38, wherein said adjusting unit comprises a transmit element for transmitting a sync signal adjusting signal indicating the timing and/or the sync rate and receivable by other devices for controlling shutter glasses.

40. A device according to claim 38, wherein said receive element comprises a receiving element for receiving said signal wirelessly.

41. A method for controlling shutter glasses used in a 3D display system, comprising:
generating sync signals used to synchronize shutter glasses with a 3D display system, the sync signals having a timing and a sync rate;
transmitting said sync signals so that the signals are receivable by shutter glasses; and
transmitting an adjusting signal indicating the timing and/or the sync rate of the generated sync signals.

42. A method according to claim 41, further comprising:
receiving an adjusting signal indicating the timing and/or the sync rate; and
adjusting the timing and/or the sync rate of the generated sync signals in response to the adjusting signal.

43. A method according to claim 41, wherein said adjusting signal is transmitted wirelessly.

44. A method according to claim 41, further comprising:
an arbitration between plural participating 3D display systems for finding and determining a timing and/or sync rate being appropriate for all participating 3D display systems.

45. A method for controlling shutter glasses used in a 3D display system, comprising:
generating sync signals used to synchronize shutter glasses with a 3D display system, the sync signals having a timing and a sync rate;
transmitting said sync signals so that the signals are receivable by shutter glasses;
receiving an adjusting signal indicating the timing and/or the sync rate; and
adjusting the timing and/or the sync rate of the generated sync signals in response to the adjusting signal.

46. A method according to claim 45, further comprising:
transmitting an adjusting signal indicating the timing and/or the sync rate of the generated sync signals.

47. A display system for displaying 3D content, or motion pictures, comprising a device for controlling shutter glasses as defined in claim 31.

48. A display system according to claim 47, wherein the system comprises a video game console.

49. A display system according to claim 47, wherein said device for controlling shutter glasses is provided as a separate unit comprising an interface for coupling with the display system.

50. A system comprising at least two display systems according to claim 47.
